(19) United States
(12) Patent Application Publication
(10) Pub. No.: US 2025/0075859 A1
(43) Pub. Date: Mar. 6, 2025

(54) NON-VACUUM CARGO CONTAINMENT SYSTEMS

(71) Applicant: CB&I STS Delaware LLC, The Woodlands, TX (US)

(72) Inventors: David CREECH, Glen Ellyn, IL (US); Alexander COOPERMAN, Lisle, IL (US)

(21) Appl. No.: 18/817,935

(22) Filed: Aug. 28, 2024

Related U.S. Application Data
(60) Provisional application No. 63/579,899, filed on Aug. 31, 2023.

(51) Int. Cl. F17C 13/00

(52) U.S. Cl. CPC F17C 13/001; F17C 2203/0329; F17C 2203/0621; F17C 2203/0636; F17C 2203/0658; F17C 2221/012; F17C 2223/0161

(57) ABSTRACT

The present disclosure provides liquid gas transport containers. The liquid gas transport containers include a first membrane defining a cavity. A first insulation layer is disposed around the first membrane. The first insulation layer includes a first closed-cell insulation material. The first closed-cell insulation material includes a first syntactic foam. A backing material is disposed around the first insulation layer. A hull is disposed around the backing material.

### CROSS-REFERENCE TO RELATED APPLICATIONS

This application claims priority to U.S. Provisional Patent Application Ser. No. 63/579,899, filed on Aug. 31, 2023, which is herein incorporated by reference in its entirety.

### BACKGROUND

### Field

Embodiments of the present disclosure generally relate to a cryogenic vessel for storing liquid hydrogen.

### Description of the Related Art

Membrane transport vessels for liquid natural gas are formed from a first membrane disposed over a first insulation layer. The first membrane is made of metal panels including one or more corrugations, where the membrane can be as thin as 0.7 millimeters (mm). The first membrane panels are joined by welds. The total length of welds in a liquid natural gas transport vessel can exceed 100 km. Even with very good welding quality control, there is a possibility of leaks throughout the membrane. Approaches to manage these leaks have included circulating an inert gas such as nitrogen between the first membrane and the first insulation layer within channels formed by the corrugations. The inert gas acts to sweep any natural gas leaks so that the natural gas leaks can be detected and the natural gas can be removed.

Hydrogen is an energy source that is an alternative to conventional fossil fuels, e.g., liquid natural gas. For example, some modes of transportation, such as cars, are powered by hydrogen fuel cells. Hydrogen also has applications in other industrial applications, such as the Haber-Bosh process to produce fertilizer. As demand for hydrogen increases, due in part to the development of more efficient hydrogen powered vehicles and machines and consumer adoption thereof, there is a need to transport and/or store hydrogen in industrial quantities.

Hydrogen gas has a low density. To efficiently transport industrial quantities of hydrogen gas, the hydrogen gas is liquefied. However, liquefied hydrogen is extremely cold which places stress on its transport container. For example, the boiling point of liquefied hydrogen at one atmosphere of pressure is about −253° C. (20° K). Therefore, liquid hydrogen is typically transported at conditions close to ambient pressure and a temperature of approximately 20 Kelvin.

Transport of liquid hydrogen utilizes insulation to reduce heat transfer between the liquid hydrogen and the hull of the ship. Without insulation the liquid hydrogen would rapidly change phase into gaseous hydrogen (commonly referred to as boil-off) and would need to be released from the tank to avoid an excessive increase in pressure, thereby leading to potential safety concerns.

Currently, liquid hydrogen must be transported by vacuum-insulated independent tanks, such as tanks with a largely spherical shape. However, it is desirable to utilize membrane transport vessels for liquid hydrogen, as membrane transport vessels can fill the hull more efficiently than independent tanks. Unfortunately, nitrogen gas cannot manage leaks in a membrane transport vessel for liquid hydrogen because the nitrogen would condense and/or freeze.

Therefore, what is needed in the art is improved methods of insulating liquid hydrogen gas transport vessels.

### SUMMARY

The present disclosure generally relates to a cryogenic vessel for storing liquid hydrogen.

In an aspect, the present disclosure provides liquid gas transport containers. The liquid gas transport containers include a first membrane defining a cavity. A first insulation layer is disposed around the first membrane. The first insulation layer includes a first closed-cell insulation material. The first closed-cell insulation material includes a first syntactic foam. A backing material is disposed around the first insulation layer. A hull is disposed around the backing material.

In another aspect, the present disclosure provides liquid gas transport containers. The liquid gas transport containers include a first membrane defining a cavity. A first insulation layer is disposed around the first membrane. The first insulation layer includes a first closed-cell insulation material. A second membrane is disposed around the first insulation layer. A first intermediate shell is disposed around the first insulation layer. The first intermediate shell is disposed between the first membrane and the first insulation layer. The first intermediate shell is disposed between the first insulation layer and the second membrane. A backing material is disposed around the second membrane. A hull is disposed around the backing material.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 illustrates a schematic cross-sectional side view of a liquid hydrogen transport container, according to embodiments described herein.

FIG. 2A illustrates a schematic cross-sectional view of a first membrane and a first insulation layer forming the liquid hydrogen storage container of FIG. 1, according to embodiments described herein.

FIG. 2B illustrates a schematic cross-sectional view of a first membrane and a first insulation layer forming the liquid hydrogen storage container of FIG. 1, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to a cryogenic vessel for transporting liquid hydrogen. More specifically, the disclosure relates to a cryogenic vessel with one or more insulation layers which maintain their insulating properties after exposure to hydrogen and enable improved transport efficiency of large volumes of liquid hydrogen. The transport vessels include a membrane comprising one or more corrugations. A first insulation layer is coupled to the first membrane, the first insulation layer including materials with low permeability to hydrogen. Advantageously, the cryogenic transport vessel of the present disclosure can provide enhanced transport efficiency compared to vacuum-insulated spherical transport vessels, in which the cryogenic transport vessels of the present disclosure can fill space in the hull more efficiently than spherical vessels.

Hydrogen gas has a thermal conductivity that is up to 7 times higher than nitrogen and can readily diffuse into insulation materials due to the small size of hydrogen molecules. When the insulation material is a closed-cell foam, the presence of hydrogen inside the void spaces of the foam could increase the effective thermal conductivity of the closed-cell foam material. If the first insulation layer of a membrane transport vessel were exposed to hydrogen due to hydrogen permeation through the membrane, then the insulation effectiveness would be compromised, leading to elevated transfer of heat into the hydrogen product and resulting product losses through boil-off, and potentially to low temperatures in the hull which could result in unacceptable embrittlement of the steel material.

The transport vessel of the present disclosure can insulate liquid hydrogen without hydrogen permeation to an insulation layer would significantly reduce the cost of large-scale liquid hydrogen transport compared to conventional liquid hydrogen transport vessels, e.g., spherical liquid hydrogen transport vessels. In the embodiments described herein, liquid hydrogen product is stored within a transport volume. The transport volume is a space defined by an inner surface of a first membrane. An inner surface of the first insulation layer is coupled to an outer surface of the first membrane. An inner surface of a second membrane is coupled to an outer surface of the first insulation layer. An inner surface of a second insulation layer is coupled to an outer surface of the second membrane. An outer surface of the second insulation layer is attached to a backing material 118.

The first insulation layer and/or the second insulation layer include a closed-cell foam. The closed-cell form can include a closed-cell polymer foam, e.g., a polyurethane foam, a polyurea foam, a polyethylene foam, polypropylene foam, polystyrene foam, or a combination thereof. In some embodiments, which can be combined with other embodiments, the first insulation layer and/or the second insulation layer can include a cellular glass insulation. The closed-cell polymer foam can include a syntactic foam where a void of a foam cell within the syntactic foam is formed by perlite and/or glass microspheres, e.g., hollow microspheres, in the matrix of the polymer. Without being bound by theory, the perlite, glass microspheres, hollow microspheres, and/or glass bubbles can reduce permeability of the first insulation layer and/or the second insulation layer, thereby reducing hydrogen permeation to the first insulation layer and/or second insulation layer.

The first insulation layer and/or the second insulation layer may be surrounded by an intermediate shell. The intermediate shell may be substantially impermeable, thereby preventing hydrogen and/or other gases from permeating the first insulation layer and/or the second insulation layer. For example, the first insulation layer and the second insulation layer may be surrounded by the intermediate shell, thereby reducing thermal conductivity due to hydrogen permeation, and increasing cold transport efficiency. In some embodiments, the first insulation layer and/or the second insulation layer can include a plurality of closed-cell foam components, e.g., closed-cell foam blocks. Each of closed-cell foam component of the plurality of closed-cell foam components can be surrounded by the intermediate shell.

The insulation layer structure described herein can be used in any application that stores or transports cryogenic liquids, such as LNG carriers, cargo containment systems, transport vessels, pipes, or a combination thereof. For example, the insulation layer structure described herein can transport liquid helium or liquids with a higher temperature. Polygonal liquid gas storage containers are illustrated, however, the insulation layers, membranes, and shell structures described herein may also be used for spherical transport vessels, cylindrical transport vessels, or transport vessels with other shapes.

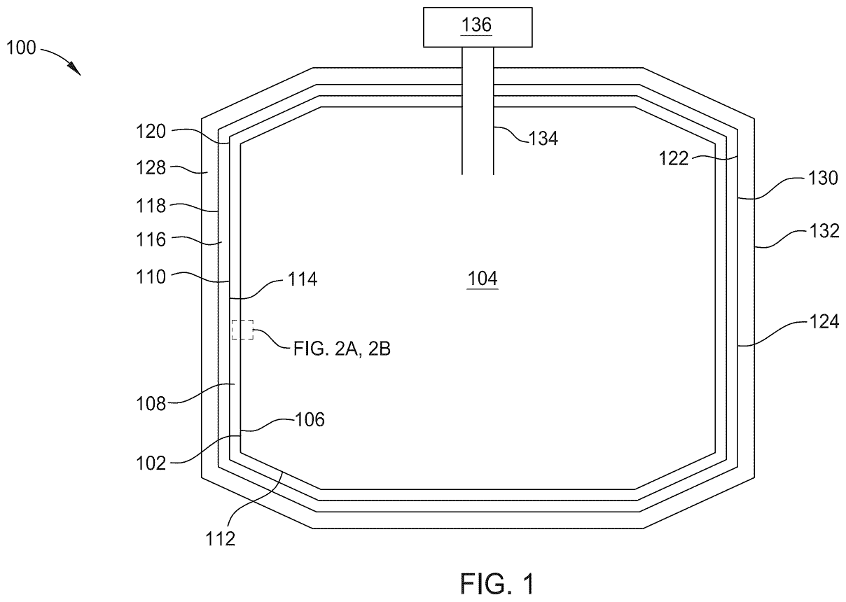

FIG. 1 illustrates a schematic cross-sectional side view of a liquid gas transport container 100. The liquid gas transport container 100 includes a first membrane 102 which forms a cavity 104. The cavity 104 is formed by an inner surface 106 of the first membrane 102. The cavity 104 is configured to hold liquid hydrogen or another liquid gas. The cavity 104 may have a volume of greater than 3,000 m³, such as greater than 4,000 m³, such as greater than 5,000 m³, such as greater than 6,000 m³, such as greater than 6,500 m³, such as greater than 7,000 m³, such as greater than about 10,000 m³, such as greater than about 50,000 m³, such as greater than about 75,000 m³, or such as greater than about 100,000 m³. In some embodiments, the volume is about 5,000 m³ to about 250,000 m³, or greater, such as about 50,000 m³ to about 100,000 m³. The first membrane 102 is formed of a cryogenic metal material, such as a cryogenic steel or another cryogenic metal alloy capable of being utilized at temperatures of about 20 Kelvin. For example, the first membrane 102 can include a cryogenic steel such as 304L stainless steel. The first membrane can include a thickness of about 0.1 millimeters (mm) to about 10 mm, e.g., about 0.1 mm to about 5 mm, about 0.5 mm to about 5 mm, or about 1 mm to about 5 mm. The first membrane has one or more corrugations as described herein.

A first insulation layer 108 is formed around the first membrane 102. The first insulation layer 108 is defined by the first membrane 102 and a second membrane 110. The first insulation layer 108 is disposed around first membrane 102, such that the first insulation layer 108 is wrapped around the first membrane 102 and covers an outer surface 112 of the first membrane 102. The first insulation layer 108 is attached to the outer surface 112 of the first membrane 102. The first insulation layer 108 can be attached to the outer surface 112 of the first membrane 102 via one or more mechanical bonds, e.g., welding, and/or one or more chemical bonds. For example, the first insulation layer 108 is chemically bonded to the outer surface 112, in which the chemical bond can include forming a bond using an epoxy bond and/or forming a bond via a reaction between the first insulation layer 108 and the outer surface 112. As a further example, the first insulation layer 108 is mechanically bonded to the outer surface 112 via one or more welding joints that secure the first insulation layer 108 to the outer surface 112.

The first insulation layer 108 can include a plurality of closed-cell foam components, e.g., closed-cell foam blocks. Each of closed-cell foam component of the plurality of closed-cell foam components independently includes a closed cell-insulation material. The closed-cell insulation material can include one or more closed-cell foams and/or cellular glass insulation. In some embodiments, the closed-cell foams can include foams including one or more of polyethylene, polyurea, polyurethane, polyisocyanurate, polypropylene, and/or polystyrene.

Closed-cell foams are formed by cells that have thin polymeric membranes arranged in polyhedral shapes, e.g., about 0.01 mm to about 1.0 mm, such as about 0.01 mm to about 0.5 mm, about 0.05 mm to about 0.1 mm, or about 0.07 to about 0.1 mm. The cells are filled with gas such as a blowing agent, which is a gas that is used to expand the cells in the foam. For example, a blowing agent can include an unsaturated organic compound such as hydrofluoroolefin. At room temperature atmospheric gases, such as nitrogen, can diffuse into the cells, in which the blowing agent diffuses out.

Closed-cell foams include syntactic foams. The syntactic foams can include perlite, glass microspheres, hollow microspheres, and/or glass bubbles in a matrix of the polymeric material. Without being bound by theory, perlite, glass microspheres, hollow microspheres, and/or glass bubbles can reduce permeability of the closed-cell foam, thereby reducing hydrogen permeation to the first insulation layer. Additionally, and without being bound by theory, perlite, glass microspheres, hollow microspheres, and/or glass bubbles can reduce thermal contraction, thereby reducing a pressure differential between the cavity 104 and the outer surface 112 of the first membrane 102. When the outer surface 112 of the first membrane 102 is cooled down, gases in the cells of the first insulation layer 108 proximal to the outer surface 112 also cool. The gases can liquefy and/or solidify. When the gases liquefy and/or solidify, the pressure in the cell drops, creating a pressure difference across the cell wall of the closed-cell foam. The pressure differential can be about 0.01 atm to about 1 atm, e.g., about 0.01 atm to about 0.5 atm, about 0.01 atm to about 0.1 atm, or about 0.01 atm to about 0.05 atm. When the cell wall of the closed-cell foam is permeable to gases, the gas will diffuse from surrounding cells with higher pressure into the cell with low pressure, and can liquefy. This process can continue until the cells proximal to the outer surface 112 are substantially filled with liquefied and/or frozen gases. Upon warming of the outer surface 112, such as during maintenance, the liquefied and/or solidified gases will vaporize, and can rupture the cells.

To prevent damage the closed-cell foam can be cooled to cryogenic temperatures, thereby reducing and/or preventing diffusion of gases into a cell of the closed-cell foam due to reduced permeability of the closed-cell foam. Without being bound by theory, by reducing permeability of the closed-cell foam the likelihood of rupture when warming the closed-cell foam is reduced. Moreover, and without being bound by theory, the first insulation layer 108 can reduce complications of insulation performance damage upon warming the first membrane 102.

The first insulation layer 108 is filled with a first gas, such as a blowing agent, nitrogen or a nitrogen containing mixed gas. For example, the first insulation layer 108 can initially be filled with a first gas of hydrofluoroolefin, in which after a period of time, e.g., seconds, minutes, hours, days, years, or decades, the first insulation layer 108 can be filled with a second gas of nitrogen. In some examples, the first insulation layer 108 may be filled with air with concentrations similar to those found in ambient air. The first insulation layer 108 is used adjacent to the first membrane 102 and the first insulation layer 108 is thick enough so the temperature at an outer surface 114 of the first insulation layer 108 is above the condensation temperature of gas in a second insulation layer 116, e.g., about 77 Kelvin (the point at which nitrogen boils or liquefies).

The closed-cell insulation material which forms the first insulation layer 108 has a cell size (diameter) of less than about 1 μm to about 1 cm, such as 0.1 mm to about 1.0 mm. For example the pore diameter of the closed-cell insulation mater can be about 10 μm to about 100 μm. The first insulation layer 108 has a first conductivity of about 0.0001 W/(m·K) to about 0.050 W/(m·K), such as about 0.010 W/(m·K) to about 0.040 W/(m·K), such as about 0.010 W/(m·K) to about 0.030 W/(m·K), such as about 0.015 W/(m·K) to about 0.030 W/(m·K), such as about 0.020 W/(m·K) to about 0.030 W/(m·K). The first insulation layer 108 includes a thickness of about 1 mm to about 500 mm, e.g., about 1 mm to about 450 mm, about 100 mm to about 450 mm, about 250 mm to about 400 mm, or about 250 mm to about 350 mm. The first insulation layer includes a density of about 15 kg/m³ to about 200 kg/m³, e.g., about 20 kg/m³ to about 150 kg/m³, about 30 kg/m³ to about 100 kg/m³, or about 40 kg/m³ to about 60 kg/m³.

The second membrane 110 is formed from a metal material, e.g., a cryogenic metal material or a metal alloy. The second membrane can include a cryogenic steel, a cryogenic alloy, a metal steel, and/or a metal alloy. For example, the second membrane 110 can include a metal alloy such as an iron nickel alloy. The iron-nickel alloy can include about 30 wt % to about 40 wt % of iron and about 60 wt % to about 70 wt % of nickel. The second membrane 110 can include a thickness of about 0.1 mm to about 10 mm, e.g., about 0.1 mm to about 5 mm, about 0.5 mm to about 5 mm, or about 0.6 mm to about 0.8 mm. The second membrane 110 has one or more corrugations and/or tongues which may improve flexibility of the second membrane 110, thereby allowing for flexion due to thermal expansion differences during cooling and/or heating. Additionally, and/or alternatively, the one or more corrugations and/or tongues may allow for inert gas to be circulated through the second membrane to maintain suitable pressure to prevent buckling of the second membrane, the first insulation layer, and/or the first membrane.

The second insulation layer 116 is disposed between the second membrane 110 and a backing material 118. The second insulation layer 116 is disposed on an outer surface 120 of the second membrane 110, and an inner surface 122 of the backing material 118. The second insulation layer 116 may include a closed-cell foam material that is similar to the first insulation layer 108. The second insulation layer 116 may include a closed-cell foam that is different than the first insulation layer 108. The second insulation layer 116 may include a thermal conductivity that is higher than the thermal conductivity of the first insulation layer 108. The second insulation layer 116 can include a plurality of closed-cell foam components, e.g., closed-cell foam blocks. Each of closed-cell foam component of the plurality of closed-cell foam components independently includes a closed cell-insulation material. The closed-cell insulation material can include one or more closed-cell foams and/or cellular glass insulation. In some embodiments, the closed-cell foams can include foams including one or more of polyethylene, polyurea, polyurethane, polyisocyanurate, polypropylene, and/or polystyrene.

The second insulation layer 116 is filled with a second gas, which may be a single gas or a combination of gases combination. The second gas can be the same as the first gas. The second gas may be over 50% nitrogen, over 50% argon, or over 50% of a combination of nitrogen and argon when measured by partial pressures. In some embodiments, the second gas combination may be over 60% of one or a combination of nitrogen and argon, such as over 70% of one or a combination of nitrogen and argon, such as over 80% of one or a combination of nitrogen and argon, such as over 90% of one or a combination of nitrogen and argon. The nitrogen and/or argon concentration within the first insulation layer 108 may be maintained by exposing the first insulation layer 108 to a nitrogen and/or argon gas source. In some examples, dry air may be utilized. A nitrogen and/or argon gas may be used in the second insulation layer 116 during formation of the second insulation layer 116 onto the outer surface 120 of the second membrane 110.

The second insulation layer 116 has a second conductivity of about 0.010 W/(m·K), to about 0.100 W/(m·K). The thermal conductivity of the first insulation layer 108 may be 2 times less than the thermal conductivity of the second insulation layer 116, such as 3 times less than the thermal conductivity of the second insulation layer 116, such as 4 times less than the thermal conductivity of the second insulation layer 116, such as 5 times less than the thermal conductivity of the second insulation layer 116, such as 7 times less than the thermal conductivity of the second insulation layer 116, such as 10 times less than the thermal conductivity of the second insulation layer 116.

Optionally, the temperature of the outer surface 114 of the first insulation layer 108 is above the condensation temperature of the gas or mixture of gases in the second insulation layer 116 to prevent condensation and run-away cryopumping. For example, the outer surface 114 may be above the condensation temperature of the blowing agent and/or gas of the second insulation layer 116.

Optionally, the pressure may be maintained under vacuum conditions and/or substantially above full vacuum. For example, the absolute pressure within the first insulation layer 108 may be about 1×10⁻⁶ atm to about 2 atm, such as about 1×10⁻⁶ atm to about 1 atm, about 1×10⁻³ to about 0.1 atm, or about 0.01 to about 0.1 atm. As a further example, the absolute pressure within the second insulation layer 116 may be maintained at about 1×10⁻⁶ atmospheres to about 2 atmospheres, such as about 1×10⁻⁶ atmospheres to about 1.5 atmospheres, such as about 1×10⁻³ atmospheres to about 1.25 atmospheres, such as about 0.01 atmospheres to about 1.2 atmospheres, such as about 0.1 atmospheres to about 1.1 atmospheres, such as about 0.95 atmospheres to about 1.05 atmospheres, such as at about 1 atmosphere.

In some embodiments, which can be combined with other embodiments, the absolute pressures within the first insulation layer 108 may be about 1.0 atmospheres at a first surface thereof, but reduces in pressure to about 0.2 atmosphere or less, to about 1×10⁻⁶ atmosphere or less, near the first membrane 102. In some embodiments, which can be combined with other embodiments, the absolute pressures within the second insulation layer 116 may be about 1.0 atmospheres at a first surface thereof, but reduces in pressure to about 0.2 atmosphere or less, to about 1×10⁻³ atmosphere or less, near the second membrane 110. The absolute pressures near the first membrane 102 and/or the second membrane 110 may be regulated by adjusting the vacuum throughout the corrugations as described herein. In some embodiments, which can be combined with other embodiments, the absolute pressure within the first insulation layer 108 and/or the second insulation layer 116 may be consistent throughout the membrane, in which the absolute pressure may be about 1×10⁻⁶ atm to about 0.1 atm.

The backing material 118 may include a backing adhesive. The backing adhesive may be coupled to the second insulation layer 116. The backing adhesive can include one or more support structures. The support structure can provide stability to the backing material 118. Without being bound by theory, the backing material 118 can provide support to the second insulation layer 116 such that the second insulation layer 116 remains substantially uniform in shape.

An outer surface 124 of the backing material 118 contacts a hull 128. The hull 128 can include the hull of a vessel, e.g., an LNG vessel. The hull 128 includes an inner surface 130 and an outer surface 132. The inner surface 130 of the hull 128 contacts the outer surface 124 of the backing material 118. The outer surface 132 of the hull 128 contacts the ambient environment, e.g., water, air, and/or another ambient medium.

A conduit 134 extends into the cavity 104 and through each of the first membrane 102, the first insulation layer 108, the second membrane 110, the second insulation layer 116, the backing material 118, and the hull 128. The conduit 134 may be a pipe or a tube which extends into the cavity 104 in order to either fill or drain the cavity 104 of liquid hydrogen. The conduit 134 is disposed such that an open end of the conduit 134 is within the cavity 104 while another end of the conduit 134 is connected to a hydrogen source 136 outside of the body of the liquid gas transport container 100. The hydrogen source 136 may include a pump or a condenser as well as one or more feed lines to various other hydrogen sources. While only a single conduit is shown, it is to be understood than more than one conduit may be included, such as a conduit for filling, one for withdrawal, one for venting boil-off gas, and optionally other conduits. In some examples, the filling and boil off conduits through the top, while the withdrawal line may be through the top or bottom. Other configurations are also contemplated.

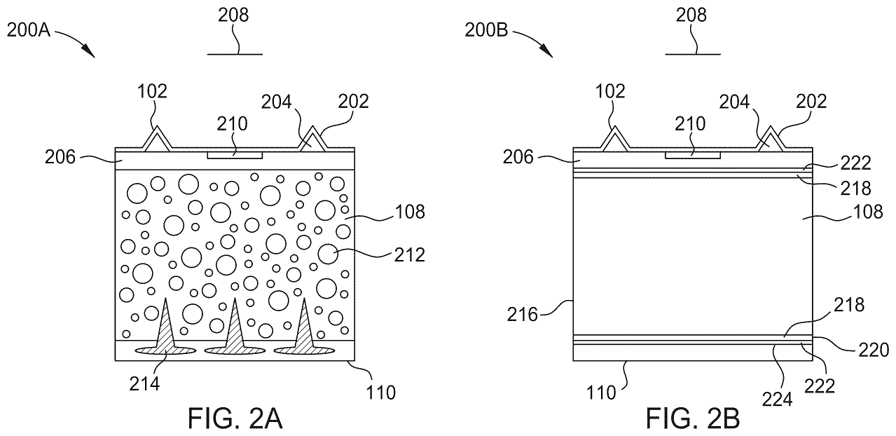

Now referring to FIG. 2A, a schematic cross-sectional side view of a liquid gas container 200A having a first membrane 102 disposed over a first insulation layer 108 is shown. The first membrane 102 includes one or more corrugations 202. The one or more corrugations 202 may be welded together to form the first membrane 102. The one or more corrugations may be raised to provide a membrane cavity 204 between the outer surface 112 of the first membrane 102 and a membrane support layer 206. The membrane cavity 204 may be placed under vacuum and/or filled with one or more gases to allow the gases to condense and thereby produce a vacuum, e.g., argon, nitrogen, helium, or a combination thereof. Without being bound by theory, a membrane cavity 204 that is placed under vacuum may prevent hydrogen from permeating to the first insulation layer 108, thereby maintaining thermal conductivity efficiency of the first insulation layer 108. Additionally, and without being bound by theory, the one or more gases may fill the membrane cavity 204 to produce a positive pressure on the first membrane 102, thereby reducing and/or preventing hydrogen permeation through the one or more corrugations 202.

The membrane support layer 206 can include a structural material configured to provide a level surface for the first membrane 102. For example, the membrane support layer 206 can include a wood material, a polymer material, a metal material, a ceramic material, or a combination thereof. For example the membrane support layer 206 can include wood, e.g., plywood. The membrane support layer 206 includes at least a recess 208. The recess 208 can be disposed beneath the first membrane 102, located between a first corrugation and a second corrugation. The recess 208 can be filled with a metal material 210. The metal material 210 can include a ductile metal, e.g., a metal suitable to be welded. For example, the ductile metal can include stainless steel, aluminum, metal alloys, iron, nickel, copper, or a combination thereof. For example, the ductile metal can include a metal alloy such as an iron nickel alloy. The iron-nickel alloy can include about 30 wt % to about 40 wt % of iron and about 60 wt % to about 70 wt % of nickel.

The membrane support layer 206 is disposed over the first insulation layer 108. The first insulation layer 108 and/or the second insulation layer 116 can include a plurality of microspheres 212, e.g., a glass microsphere, hollow microsphere, and/or a glass bubble. The plurality of microspheres 312 can include an average microsphere diameter of about 1 micrometers (μm) to about 200 μm, e.g., about 1 μm to about 100 μm, about 5 μm to about 100 μm, or about 50 μm to about 80 μm. Without being bound by theory, the plurality of microspheres 212 can reduce permeability of the first insulation layer 108 and/or the second insulation layer 116 such that hydrogen permeability into the plurality of microspheres 212 is minimal and/or eliminated.

The first insulation layer 108 may be secured to the second membrane 110 via one or more anchoring devices 214. The one or more anchoring devices 214 can include a mechanical fastener, e.g., screw, nail, pin, staple, or a combination thereof.

While FIG. 2A or 2B represent a schematic cross-sectional side view of a first membrane 102 and a first insulation layer 108, any membrane and insulation layer may be oriented similarly, e.g., the second membrane 110, the second insulation layer 116, and the backing material 118 may be oriented and/or structured similarly to the representation of FIG. 2A or 2B.

Optionally, a liquid gas container 200B includes an intermediate shell 216 as shown in FIG. 2B. The intermediate shell 216 may be an impermeable membrane, such as metallic or non-metallic, depending upon the embodiment and the types of insulation utilized in one or both of the first insulation layer 108 and the second insulation layer 116. In some examples, when using an impermeable membrane as the intermediate shell, a closed cell foam and/or an open cell foam may be used as the first insulation layer 108.

The intermediate shell 216 is an impermeable membrane, such that gases or liquid do not pass through the intermediate shell 216, but the intermediate shell 216 is still capable of flexing and bending to maintain contact with the first insulation layer 108 and/or the second insulation layer 116. The intermediate shell 216 may be impermeable at a temperature of about 50 Kelvin to about 100 Kelvin, such as about 60 Kelvin to about 90 Kelvin, such as about 70 Kelvin to about 90 Kelvin, such as about 75 Kelvin to about 85 Kelvin. The intermediate shell 216 is impermeable at least in part because the coefficient of permeability is sufficiently low to provide a predetermined level of impermeability for use of the storage vessel. Without being bound by theory, the coefficient of permeability may be low enough to prevent and/or reduce permeation of gases, e.g., hydrogen, to the first insulation layer and/or the second insulation layer.

In embodiments wherein the intermediate shell 216 is an impermeable membrane, the intermediate shell 216 may be one or a combination of epoxy, polyethylene terephthalate (Mylar), aluminized polyethylene terephthalate (aluminized Mylar), polypropylene, polyimide, polyetherimide, polyether ether ketone, or various metal foils. Other materials are also contemplated, but not listed explicitly herein. The intermediate shell 216 have a modulus of elasticity of greater than 400 kg/mm², such as greater than 500 kg/mm², such as greater than 600 kg/mm², such as greater than 700 kg/mm² at a temperature of about 77 Kelvin. The membrane may have a thickness of about 0.1 mm to about 10 mm, e.g., about 0.1 mm to about 8 mm, about 0.5 mm to about 5 mm, or about 1 mm to about 3 mm. Without being bound by theory, a thickness of the membrane of about 0.1 mm to about 10 mm may allow the membrane to flex such that tears and/or cracks are avoided while coating the first insulation layer 108 and/or the second insulation layer 116. The modulus of elasticity allows the membrane to flex along with the first insulation layer 108 and/or the second insulation layer 116 as the first insulation layer 108 and/or the first membrane 102 shrinks and expands during cooling and heating of the first insulation layer 108 and the first membrane 102. The membrane also helps seal the first insulation layer 108 from the second insulation layer 116, and the second insulation layer 116 from the backing material 118. Therefore, if there are any gaps or cracks within the first insulation layer 108, the effects of cryopumping may be reduced or eliminated by the presence of the membrane. The use of an intermediate shell 216 which is a flexible membrane may further enable additional materials to be utilized as part of the first insulation layer 108, such as open-cell foam.

The intermediate shell 216 may be formed of a material which is not self-supporting, or is otherwise flexible. The first insulation layer 108 and/or the second insulation layer 116 may be a self-supporting layer. In some embodiments, the first insulation layer 108 and/or the second insulation layer 116 when the intermediate shell 216 is an impermeable membrane. In such an example, the first insulation layer 108 has sufficient structural rigidity to support pressures exerted by the gas in the second insulation layer 116 and/or the second membrane 110. Rigid closed-cell foam may be examples of self-supporting materials which can be used in the first insulation layer 108 and/or the second insulation layer 108. The insulation material of the first insulation layer 108 and/or the second insulation layer 116 may include a compressive strength of about 14 psi to about 100 psi, e.g., about 14 psi to about 90 psi, about 20 psi to about 80 psi, or about 30 psi to about 70 psi, to support the loads transmitted through the impermeable membrane from both the differential pressure and any forces exerted by the first insulation layer 108, the second insulation layer 116, the first membrane 102, and/or the second membrane 110.

An inner surface 218 of the intermediate shell 216 may be bonded to the first insulation layer 108 and/or the second insulation layer 116 using an insulation adhesive 220. The insulation adhesive 220 can include a polymer adhesive, an epoxy adhesive, a synthetic adhesive, a conductive adhesive, a wet adhesive, a contact adhesive, and/or an acrylate adhesive. For example, the insulation adhesive 220 can include a cryogenic epoxy adhesive. Without being bound by theory, a cryogenic epoxy adhesive can further prevent permeation of gases through the insulation adhesive, thereby reducing and/or preventing hydrogen permeation into an insulation layer, e.g., the first insulation layer 108 and/or the second insulation layer 116. The insulation adhesive 220 can chemical bonded the first insulation layer 108 to the inner surface 218 of the intermediate shell 216, and/or the second insulation layer 116 to the inner surface 218 of the intermediate shell 216. The chemical bond can include forming a bond via a reaction between the first insulation layer 108 and the inner surface 218 of the intermediate shell 216.

An outer surface 222 of the intermediate shell 216 may be bonded to the first membrane 102, the membrane support layer 206 and/or the second membrane 110 using a membrane adhesive 224. The membrane adhesive 224 can be similar to the insulation adhesive 220. The membrane adhesive 224 can be different than then insulation adhesive 220. The membrane adhesive 224 can include a polymer adhesive, an epoxy adhesive, a synthetic adhesive, a conductive adhesive, a wet adhesive, a contact adhesive, and/or an acrylate adhesive. For example, the membrane adhesive 224 can include a cryogenic epoxy adhesive. Without being bound by theory, a cryogenic epoxy adhesive can further prevent permeation of gases through the insulation adhesive, thereby reducing and/or preventing hydrogen permeation into an insulation layer, e.g., the first insulation layer 108 and/or the second insulation layer 116. The membrane adhesive 224 can chemically bond the intermediate shell 216 to the membrane support layer 206, the first membrane 102, and/or the second membrane 110. The chemical bond can include forming a bond via a reaction between the intermediate shell 216 and the membrane support layer 206, the first membrane 102, and/or the second membrane 110.

The intermediate shell 216 may be bonded to a sidewall of the first insulation layer 108 and/or the second insulation layer 116. For example, the intermediate shell 216 may be bonded to a sidewall of a closed-cell foam component, e.g., closed-cell foam block, of the plurality of closed-cell foam components that form the first insulation layer 108 and/or the second insulation layer 116. The intermediate shell 216 may be bonded to the sidewall using a sidewall adhesive. The sidewall adhesive can be similar to the insulation adhesive 220 and/or the membrane adhesive 224. The sidewall adhesive can be different than the membrane adhesive 224 and/or the insulation adhesive 220. The sidewall adhesive can include a polymer adhesive, an epoxy adhesive, a synthetic adhesive, a conductive adhesive, a wet adhesive, a contact adhesive, and/or an acrylate adhesive. For example, the sidewall adhesive can include a cryogenic epoxy adhesive. The sidewall adhesive can chemically bond the intermediate shell 216 to the first insulation layer 108 and/or the second insulation layer 116. The chemical bond can include forming a bond via a reaction between the intermediate shell 216 and the first insulation layer 108 and/or the second insulation layer 116.

The embodiments described herein enable a better and more reliable apparatus for insulating liquid gas transport containers, such as liquid natural gas (LNG) carriers, cargo containment systems, transport vessels, pipes, or a combination thereof. The embodiments described herein are more economic and provide greater transportation efficiency. Disclosed embodiments reduce gaseous diffusion into insulation layers, e.g., a first insulation layer and/or a second insulation layer, while improving volume capabilities, thereby maintaining reduced thermal conductivity and improved cryogenic transport capabilities. Advantageously, the cryogenic transport vessel of the present disclosure can provide enhanced transport efficiency compared to vacuum-insulated spherical transport vessels, in which the cryogenic transport vessels of the present disclosure can fill space in the hull more efficiently than spherical vessels.

While the foregoing is directed to embodiments of the present disclosure, other and further embodiments of the disclosure may be devised without departing from the basic scope thereof, and the scope thereof is determined by the claims that follow.

What is claimed is:

1. A liquid gas transport container comprising:
a first membrane defining a cavity;
a first insulation layer disposed around the first membrane, the first insulation layer comprising a first closed-cell insulation material, wherein the first closed-cell insulation material comprises a first syntactic foam;
a backing material disposed around the first insulation layer; and
a hull disposed around the backing material.

2. The liquid gas transport container of claim 1, further comprising:
a second membrane disposed around the first insulation layer; and
a second insulation layer disposed around the second membrane, the second insulation layer comprising a second closed-cell insulation material.

3. The liquid gas transport container of claim 2, wherein the second closed-cell insulation material comprises a second syntactic foam.

4. The liquid gas transport container of claim 3, wherein the first syntactic foam and the second syntactic foam independently comprises a plurality of hollow microspheres comprising an average microsphere diameter of about 1 micrometers (μm) to about 200 μm.

5. The liquid gas transport container of claim 2, wherein the second insulation layer comprises an absolute pressure of about 1×10⁻⁶ atm to about 1.5 atm.

6. The liquid gas transport container of claim 1, wherein the first insulation layer comprises an absolute pressure of about 1×10⁻⁶ atm to about 1.5 atm.

7. The liquid gas transport container of claim 6, wherein the first membrane comprises one or more corrugations, wherein the one or more corrugations comprise a first membrane cavity disposed between the first membrane and the first insulation layer.

8. The liquid gas transport container of claim 7, wherein the first membrane cavity disposed between the first membrane and the first insulation layer comprises a sub-atmospheric pressure.

9. A liquid gas transport container comprising:
a first membrane defining a cavity;
a first insulation layer disposed around the first membrane, the first insulation layer comprising a first closed-cell insulation material;
a backing material disposed around the first insulation layer;
a first intermediate shell disposed around the first insulation layer, wherein the first intermediate shell is disposed between the first membrane and the first insulation layer, and wherein the first intermediate shell is disposed between the first insulation layer and the backing material; and
a hull disposed around the backing material.

10. The liquid gas transport container of claim 9, further comprising:
a second membrane disposed around the first insulation layer; and
a second insulation layer disposed around the second membrane, wherein the second insulation layer comprises a second closed-cell insulation material.

11. The liquid gas transport container of claim 10, further comprising a second intermediate shell disposed around the second insulation layer.

12. The liquid gas transport container of claim 11, wherein the second intermediate shell is disposed between the second membrane and the second insulation layer, and wherein the second intermediate shell is disposed between the second insulation layer and the backing material.

13. The liquid gas transport container of claim 9, wherein the first intermediate shell comprises one or more of epoxy, polyethylene terephthalate (Mylar), aluminized polyethylene terephthalate (aluminized Mylar), polypropylene, polyimide, polyetherimide, polyether ether ketone, or metal foils.

14. The liquid gas transport container of claim 9, wherein the first intermediate shell comprises a thickness of about 0.1 (millimeters) mm to about 10 mm.

15. The liquid gas transport container of claim 9, further comprising a membrane support layer disposed between the first intermediate shell and the first membrane.

16. The liquid gas transport container of claim 15, further comprising a membrane adhesive disposed between the membrane support layer and the first intermediate shell, the membrane adhesive configured to bond the membrane support layer to the first intermediate shell.

17. The liquid gas transport container of claim 16, wherein the membrane adhesive is a polymer adhesive, an epoxy adhesive, a synthetic adhesive, a conductive adhesive, a wet adhesive, a contact adhesive, or an acrylate adhesive.

18. The liquid gas transport container of claim 17, wherein the membrane adhesive is an epoxy adhesive comprising a cryogenic epoxy adhesive.

19. The liquid gas transport container of claim 9, further comprising an insulation adhesive disposed between the first intermediate shell and the first insulation layer, the insulation adhesive configured to bond the first intermediate shell to the first insulation layer.

20. The liquid gas transport container of claim 19, wherein the insulation adhesive is a polymer adhesive, an epoxy adhesive, a synthetic adhesive, a conductive adhesive, a wet adhesive, a contact adhesive, or an acrylate adhesive, and wherein the insulation adhesive is an epoxy adhesive comprising a cryogenic epoxy adhesive.
